(19) United States
(12) Patent Application Publication
(10) Pub. No.: US 2025/0173853 A1
(43) Pub. Date: May 29, 2025

(54) METHOD AND DEVICE FOR OPTICALLY INSPECTING OBJECTS

(71) Applicant: Körber Pharma Inspection GmbH, Markt Schwaben (DE)

(72) Inventors: Marcin KWOKA, Forstinning (DE); Werner HALBINGER, Poing (DE)

(21) Appl. No.: 18/953,703

(22) Filed: Nov. 20, 2024

(30) Foreign Application Priority Data
Nov. 23, 2023 (DE) 10 2023 132 668.6

(51) Int. Cl. G06T 7/00

(52) U.S. Cl. CPC G06T 7/0004; G06T 2207/10012; G06T 2207/20012; G06T 2207/30108

(57) ABSTRACT

The disclosure relates to a method for optically inspecting at least partially transparent objects, in particular pharmaceutical containers, wherein a first and a second image of an object to be inspected are captured, wherein, for this purpose, the object is captured and/or illuminated from different angles, wherein the images differ from one another on the basis of the angular offset, wherein an abnormality in the second image is identified, wherein a mask is calculated based on the identified abnormality and the mask is applied to the first image in order to obtain a masked image of the object, and wherein the masked image is analysed to identify abnormalities in an inspection region of the object. The disclosure further relates to a corresponding inspection device and to a set for retrofitting an existing inspection device.

### CROSS REFERENCE TO RELATED APPLICATION

The present application claims priority to German Patent Application No. 10 2023 132 668.6 filed on Nov. 23, 2023. The entire contents of the above-listed application are hereby incorporated by reference for all purposes.

### TECHNICAL FIELD

The present disclosure relates to a method and to a device for optically inspecting at least partially transparent objects, in particular pharmaceutical containers, and to a set for retrofitting existing inspection devices.

### BACKGROUND

Fully automatic optical inspection systems are used in many technical sectors, such as the pharmaceutical industry, the beverage industry or the semiconductor industry, in order to identify defective objects and to reject these objects from the further production processes. When inspecting pharmaceutical containers such as vials, cartridges, syringes or ampoules, it is very important to have high inspection quality in terms of identifying abnormalities (e.g. defects or contaminants in or on the container) while as few conforming products as possible are rejected (“false rejects”).

### SUMMARY

When inspecting such objects, it is known to check different components of the objects to be inspected (e.g. stoppers, shoulders, cakes, etc.) in succession at different stations, wherein the test processes and stations are designed for the parts to be inspected there. In the process, defects and contaminants or splashes can impair or distort the inspection of the part that is actually to be checked in regions which are not of interest at a particular station.

One example of this is the optical inspection of stoppers of transparent pharmaceutical containers, which is usually carried out using a standard camera. In known devices, an image of the stopper underside is captured by means of the camera while the container is illuminated by background light and/or incident light, for example. Since the transparent side wall of the container is positioned between the stopper underside and the camera, because of a lack of depth information it is not possible to determine whether a detected abnormality (e.g. a defect or contaminant) is located on the side wall or shoulder or on the stopper. Therefore, all abnormalities having a similar size and a similar contrast result in a detection regardless of whether it is a small external contaminant (e.g. on the outside of the glass) or an abnormality in the region to be inspected (here, the stopper underside). A similar problem arises in the inspection of a lyophilisate surface in the container, for example.

Against this background, the problem addressed by the present disclosure is to increase the reliability of the inspection of such products and to reduce the number of conforming products that are rejected (“false rejects”).

According to the disclosure, this problem is solved by a method and by an inspection device as described herein.

Accordingly, first of all, a method for optically inspecting at least partially transparent objects, in particular pharmaceutical containers such as vials, cartridges, syringes or ampoules, is proposed. In the method according to the disclosure, a first image and a second image of an object to be inspected are captured under different conditions.

In this process, the images of the objects are captured at different angles, i.e. from different viewing directions (angular offset of the captured images), wherein the illumination of the object can remain the same or differ for the different shots or images. Alternatively or additionally, the object is illuminated from different angles. Optionally, not only does the illumination angle (angular offset of the illumination) differ here, but also the properties of the illuminations of the object performed from different angles. Here, the images can be captured at a single viewing angle or at different angles.

The two images of the object to be inspected thus differ on the basis of an angular offset of the capturing or viewing direction and/or on the basis of an angular offset of the illumination. According to the disclosure, an abnormality is identified in the second image. It is optionally identified automatically by means of a suitable algorithm. The abnormality identified in the second image is located in particular in a control region of the object.

In the present case, any irregularity in the object or on the object, i.e. any feature which is not is not found in a flawless object, is referred to as an abnormality. These abnormalities could therefore also be referred to as irregularities or flaws. In the present case, defects or contaminants in/on the object are in particular considered abnormalities. In a transparent container, a defect can for example be a fissure or inclusion in a glass wall, a crack on a stopper underside, a contaminant on an inner glass wall (since the stored contents are contained therein) or a contaminant on or in the contents of the container. A mere contaminant can for example be a splash on an outer glass wall.

In the present case, the control region is characterised in that it constitutes a region of the object to be inspected that is intended to be disregarded for the check for abnormalities performed as part of the method according to the disclosure. The actual inspection, i.e. the search for relevant abnormalities, is instead intended to be limited to an inspection region of the object, which in particular differs from the control region or does not overlap with it. In other words, the aim of the method according to the disclosure is to identify an abnormality in the inspection region and to not incorrectly interpret abnormalities in the control region as abnormalities in the inspection region. Abnormalities in the control region which would impair the identification of abnormalities in the inspection region during the actual inspection (or would incorrectly identify an abnormality in the inspection region) are masked out by the method according to the disclosure. For example, the inspection region can be the underside of a stopper of a vial and the control region can be a glass side wall of the vial (or part of it).

It should be emphasised here that the control region is not intended to be included in the actual inspection only in the context of the method according to the disclosure. In a preceding or subsequent step, however, the control region can certainly be the inspection region to be checked (e.g. inspection of the outer glass wall or the shoulders), while the inspection region from the present method is disregarded in this case or, where appropriate, merely constitutes a control region.

According to the disclosure, a mask is calculated based on the abnormality identified in the second image and is applied to the first image. Optionally, the first image and the generated mask, optionally also the second image, have the same size or the same dimensions (e.g. m times n pixels). By applying the mask to the first image, a masked image is generated which contains a masked representation of the object to be inspected in the view of the first image.

In the present case, masking or applying the mask can for example be understood to mean, in particular, a change in pixel values of the first image, for example by multiplying or subtracting the pixel values of the first image and the pixel values of the mask, wherein, alternatively or additionally, other functions such as AND or OR are conceivable. As a result, the masking can comprise completely hiding (e.g. minimum/maximum pixel value) certain image regions of the first image. The mask can be a binary mask.

According to the disclosure, the masked image thus obtained is then the subject of the actual check for the presence of abnormalities. Accordingly, the masked image is analysed in order to identify abnormalities such as defects or contaminants in the inspection region of the object. Here, applying the mask ensures that abnormalities in the control region are not incorrectly identified as abnormalities in the inspection region in this analysis. By masking them out, such “false rejects” can therefore be reliably avoided. Abnormalities that are not located in the inspection region but in the control region are masked out (in the simplest case, completely hidden) and are therefore not taken into account for the actual analysis. This is possible by means of the angular offset introduced according to the disclosure in the capturing direction and/or in the illumination of the object to be inspected.

In the present case, the term “image” generally refers to an optical shot of the object by means of an imaging method. This can for example be a photograph generated by means of a colour camera or a black-and-white camera. The image is in particular a digital image, i.e. a data set which comprises image information in the form of numerical values. However, in principle the images can also be analogue images.

Furthermore, in the present case, the control region and the inspection region relate to regions or parts of the object, while the images comprise optical representations of the regions of the object.

The object can in particular be illuminated with visible light, but in principle can also be illuminated with electromagnetic radiation outside the visible range (e.g. in the infrared, UV or X-ray range) or with a combination of radiation of different spectral ranges.

In the case of an angular offset of the capturing directions, the angular offset can be less than 90°, wherein, in principle, any angles are conceivable depending on the geometry of the object to be inspected. Optionally, the angular offset is in a plane which also contains a longitudinal axis of the object to be inspected. If the object rotates during the inspection, said longitudinal axis can be the axis of rotation.

Abnormalities in the second image can be identified by means of known object-identification algorithms such as edge detection and/or a threshold method. Alternatively or additionally, a machine-learning-based (in particular deep-learning-based) algorithm can be used for automatically identifying abnormalities.

In a possible embodiment, it is provided that at least one masked-out region of the masked image is excluded from the further analysis for identifying abnormalities. The at least one masked-out region is optionally in a representation of the inspection region at least in part, such that the inspection region is cleaned up by masking out external abnormalities (i.e. those not in the inspection region of the object).

In another possible embodiment, it is provided that the first and second images are captured simultaneously by means of a capturing apparatus. Here, the two images can optionally be generated by at least two separate capturing units of the capturing apparatus, in particular using an angular offset of the capturing directions. This results in a particularly rapid inspection method. Exactly two capturing units or more than two capturing units can be used.

Alternatively, in principle, the first and second images can also be generated at an angular offset by means of a single capturing unit, e.g. by the two images being captured in succession from different viewing angles and the capturing unit being moved from a first capturing position into a second capturing position. Moving the object between the two shots while the capturing unit is stationary is also conceivable. It is also possible to capture the first and second images simultaneously using corresponding optics (for example by a plurality of mirrors and/or prisms) by means of a single capturing unit.

In a configuration variant in which an angular offset of the capturing directions is not used, but instead just an angular offset of the illuminations is used to generate different images, the first and second images can also be generated by a simple capturing unit, for example by using a colour camera comprising a plurality of colour channels (in this case, each colour channel in particular uses a different colour filter in order to filter out the associated spectral range (e.g. red, green, blue, wherein spectral ranges outside the optical range, such as UV or IR, are of course also possible)). Alternatively, the images can be captured by means of a single capturing unit by capturing sequential shots using different colour and/or polarisation filters. Alternatively, a plurality of separate capturing units can be used to generate the first and second images, for example in combination with respectively allocated, different colour and/or polarisation filters.

The capturing unit(s) is/are in particular cameras, optionally combined with one or more colour and/or polarisation filters. The at least one camera can for example be a black-and-white camera or a colour camera. A combination of different cameras (e.g. a black-and-white camera and a colour camera) can also be used.

The illuminations performed from different angles can differ from one another in their properties (in particular wavelength and/or polarisation). Alternatively, identical illuminations can also be used to generate the first and second images, wherein the illuminations are performed from different angles in succession, i.e. at different points in time.

In another possible embodiment, it is provided that the control region and the inspection region constitute different and in particular non-overlapping portions of the object to be inspected, wherein the control region is in particular formed by a transparent portion of the object which lies in front of the inspection region in the viewing direction of the first image. In other words, the control region lies in front of the inspection region from the perspective of the capturing unit capturing the first image. For this reason, abnormalities in the control region are visible as abnormalities in the inspection region that is actually of interest, and this is cleaned up by applying the mask.

In another possible embodiment, it is provided that the first image comprises a representation of the inspection region and a representation of the control region. The control region represented in the first image can be a part or detail of the entire control region of the object (for example, a shot of the glass side wall of the vial from the side, wherein the entire cylindrical glass wall, optionally including the base and/or shoulders, constitutes the actual control region). In the following, however, for the sake of simplicity, a representation of “the” control region is referred to. The first image optionally contains a representation of entire inspection region (e.g. the representation of the entire underside of a stopper, captured at a certain angle).

The second image likewise comprises a representation of the control region that in particular differs from that of the first image (in particular, the representations of the inspection region can be captured at different angles and/or, in one image, the control region is shown in a different colour to in the other image).

Because both images comprise representations of the control region, from the angular offset of the capturing directions and/or the illumination, statements can be made as to whether an abnormality that appears in the represented inspection region of the first image is in actual fact in the control region. In particular, at an angular offset of the capturing directions, the position of an abnormality in the control region also changes.

When using an angular offset of the capturing directions, the representations of the control region of the first and second images can relate to slightly different details of the actual control region of the object. Optionally, the respectively detected portions of the control region largely overlap, however.

In another possible embodiment, it is provided that the object to be inspected is captured from different angles, wherein the second image is in particular captured at such an angle that the second image does not comprise a representation of the inspection region. In other words, the second image only detects abnormalities in the control region (they can also be referred to as external abnormalities) and thus does not detect any abnormalities in the inspection region, since the inspection region is not even captured or represented. The capturing unit that captures the second image therefore in particular only “sees” the control region (or a detail thereof), but not the inspection region.

In another possible embodiment, it is provided that a transformed image is generated from the second image by means of a coordinate transformation. In this case, the transformation brings the representation of the object in the second image, in particular the representation of the control region in the second image, into line with the representation of the object in the first image, in particular with the representation of the control region in the first image. In other words, the second image is transformed onto the view in the first image. This coordinate transformation can optionally also convert any distortion that may be present resulting from the angular offset of the capturing directions. Image registration algorithms that are known per se can be used for the transformation.

If two separate capturing units are used to capture the two images, at least one of the capturing units can optionally be calibrated such that a flat and/or transformed image automatically results. The calibration can be carried out before the inspection method by means of corresponding calibration measurements, for example by capturing a defined geometric pattern with an angular offset (e.g. a grid made up of lines and/or dots). The angular offset for the calibration measurement then optionally corresponds to the angular offset between the capturing directions of the method according to the disclosure. The distortions of the geometric pattern arising in the thus obtained test image can be used by means of a calibration algorithm such that the original geometric pattern or a flat image results in the calibrated image. Said calibration or the calculation of distortions arising from the angular offset can optionally be carried out as part of the above-mentioned transformation.

In addition to the angular offset, the transformation can in particular also be dependent on properties of the object to be inspected (e.g. diameter, height, etc.).

Different transformations (or optionally calibrations) can be used for different objects to be inspected (e.g. vials of different sizes). They can optionally be stored as existing files and can be used depending on the object geometry.

The mask for masking the first image is calculated based on the transformed second image. In this case, in particular those image regions or pixels in the transformed image which correspond to an abnormality identified in the second image are used to generate the mask. In this case, those pixels in the transformed image that were identified as an abnormality in the second image by means of object identification can correspond to the pixels of an image mask in relation to their arrangement. In the simplest case, a binary image mask is produced in which said transformed pixels of the identified abnormality/abnormalities are hidden or set to a certain value.

Since the mask is in particular generated from the second image transformed onto the representation of the first image, the mask can be applied directly to the first image and the corresponding image regions or pixels in the first image are changed (in the simplest case, hidden).

In another possible embodiment, it is provided that a plurality of pairs of first and second images of the object to be inspected are captured and analysed, wherein the object is moved, in particular rotated, between the shots of the image pairs. As a result, the inspection region can be inspected from different directions and/or a larger inspection region can be inspected. The object is optionally continuously rotated, wherein the first and second images are captured during the rotation of the object. Alternatively, a discontinuous rotation, i.e. a rotation that takes place in successive, discrete steps, can be used, wherein, after each rotation by a specified angle (e.g. 90°), a first and a second image are captured and the images are analysed as described above.

In general, it can be provided that the object moves past, in particular translationally moves past, the optionally stationary capturing apparatus during the inspection. At the same time, the object can rotate, as described above. In this case, the object is optionally illuminated by means of line lights, in order to make it possible to sufficiently illuminate the object that is moved past over a certain distance.

In another possible embodiment, it is provided that the object is illuminated differently from different angles, wherein a first illumination of the object is performed at a first angle and a second illumination of the object is performed at a second angle. The angular offset can be more than 90°, wherein any angles are conceivable per se depending on the geometry of the object to be inspected.

In addition to the irradiation angle, the first and second illuminations also optionally differ in their wavelength and/or their polarisation. The latter can be achieved by corresponding polarisation filters, which are positioned between the relevant illumination unit and the object. Alternatively or additionally, identical illuminations can be performed from the different angles at different points in time (time offset of the illumination).

The first and second illuminations can also originate from a single illumination unit at different points in time, i.e. the object is first illuminated from a first direction and then illuminated at a second angle with a different wavelength and/or polarisation. Alternatively, a plurality of separate illumination units can be provided, which illuminate the object simultaneously from different directions.

In an embodiment, certain properties, in particular at least the wavelengths, of the first and/or the second illumination can be changed in a targeted manner. As a result, the illumination properties can be adjusted to the object to be inspected, for example to the colour of a liquid contained in a container or the colour of a stopper to be inspected.

In another possible embodiment, it is provided that the inspection region and at least part of the control region of the object are illuminated by the first illumination. As a result, both the corresponding part of the control region and also the inspection region are represented in the first image. By contrast, at least part of the control region, but in particular not the inspection region, of the object is illuminated by the second illumination. If only the second illumination is therefore captured in the second image, the inspection region is not visible in the second image (even if, in principle, it were to be in the image region of the capturing unit that captures the second image). Similarly to the above case of the angularly offset capturing directions, the inspection region is therefore not represented in the second image because it is not illuminated.

In another possible embodiment, it is provided that the second image comprises a representation of the object generated only by the second illumination, but not a representation of the object generated by the first illumination (which also detects the inspection region). As a result, in the second image only abnormalities which are located in the control region and not in the inspection region are visible. If the two images are captured with angularly offset illumination from the same capturing direction, the mask can be generated directly from image regions or pixels that are identified as an abnormality in the second image.

The capturing unit can be a colour camera. In this case, the first and second images can be captured simultaneously by means of the same camera (i.e. the different illuminations are performed simultaneously at different wavelengths). As a result, the information represented in the relevant illumination is stored in different colour channels (e.g. green and red) or is coded by different colours, such that the second image can be “generated” or selected by selecting the associated colour channel.

The spectrally differing representations are optionally separated by means of colour filters (e.g. low-pass, high-pass, band-pass filters), and the two images are thus generated (when capturing the second image, the first illumination is then blocked by a colour filter). The latter also applies to the case of differently polarised illuminations, the associated representations of which can be separated by polarisation filters.

The use of angularly offset capturing directions and the use of angularly offset and differing illuminations can also be combined with one another. In this case, the first and second images are each captured with different illumination and from different viewing angles, optionally using two separate capturing units. They can be combined with corresponding filters in order to only let through the relevant illumination.

By combining these two principles, external abnormalities can be eliminated more accurately and reliably.

It can be provided that the object can be illuminated by a third illumination or even by more than three different illuminations. To do this, the inspection device can comprise three or more illumination units which optionally all illuminate the object from different directions or angles. They can implement a combination of transmitted light and incident light illuminations. Here, the first image can optionally be generated by illuminating the object with two or more colours simultaneously. Alternatively or additionally, the second image can also be generated by illuminating the object (at a suitable angle) with two or more colours simultaneously.

The present disclosure further relates to an inspection device for optically inspecting at least partially transparent objects, in particular pharmaceutical containers, by means of the method according to the disclosure. The inspection device according to the disclosure comprises a capturing apparatus for generating a first and a second image of an object to be inspected, an illumination apparatus and an analysis means. The object can be captured from different angles by means of the capturing apparatus and/or can be illuminated from different angles by means of the illumination apparatus, as has already been described above for the method according to the disclosure.

Said analysis means is configured to analyse the generated images, which differ from one another on the basis of the angular offset, to identify an abnormality in the second image, to calculate a mask based thereon, to apply the mask to the first image, and to analyse the thus obtained masked image for the presence of abnormalities in an inspection region of the object, as has already been described above for the method according to the disclosure. The analysis means can be a software module, which can be executed by a computer unit, in particular a computer unit of the inspection device. Alternatively, the analysis means itself can constitute a computer unit.

This clearly results in the same properties and advantages as for the method according to the disclosure, and therefore they are mostly not described again. All the above comments on possible embodiments of the method according to the disclosure are also applicable to the inspection device according to the disclosure.

The inspection device can optionally comprise an apparatus for rotating the object, in order to make it possible to capture and/or illuminate and thus inspect the object from different sides. In this case, the object can optionally be continuously rotated. Alternatively or additionally, the inspection device can comprise an apparatus for translationally moving the object, in order to move the object past the in particular stationary capturing and illumination apparatuses.

In another possible embodiment, it is provided that the capturing apparatus comprises two separate capturing units, in particular cameras, by means of which the two images can be captured simultaneously from different angles. The inspection device optionally comprises an adjusting apparatus, by means of which at least one capturing unit is movable relative to the object. As a result, images can be captured from different distances and/or angles and/or the arrangement of the capturing units can be adjusted to the object to be inspected. As a result, the inspection device can be used flexibly for different types and/or sizes of objects.

In another possible embodiment, it is provided that the illumination apparatus comprises at least two separate illumination units, by means of which the object can be illuminated simultaneously from different angles. In particular, the illuminations generated by the illumination units differ from one another in their wavelength and/or in their polarisation at least at the location of the object. This can e.g. be achieved by means of an arrangement of colour and/or polarisation filters, which can likewise be part of the inspection device. The inspection device optionally comprises an adjusting apparatus, by means of which at least one illumination unit is movable relative to the object.

At least one illumination unit, optionally all the illumination units, can be LED lights, which each emit light in one or more selectable colours. One illumination unit, a plurality of illumination units or all the illumination units can be configured as point lighting or “spotlighting”, line lighting or area lighting. A combination of point lights, line lights and/or area lights is also conceivable. Line lights are optionally used when the object to be inspected is moved past the stationary illumination apparatus, in order to ensure sufficient illumination over a relatively long distance.

The present disclosure further relates to a set for retrofitting an existing inspection device, which comprises an analysis means and a capturing apparatus and/or an illumination apparatus of the above-described inspection device. As a result, existing inspection devices can be retrofitted in a simple and cost-effective manner such that they can carry out the inspection method according to the disclosure. The above comments on embodiments of the method according to the disclosure or the various components of the inspection device are also applicable to the set according to the disclosure.

### BRIEF DESCRIPTION OF THE FIGURES

Further features, details and advantages of the disclosure are found in the following exemplary embodiments, which are explained with reference to the drawings, in which:

FIG. 1 is a schematic side view of the inspection device according to the disclosure according to a first exemplary embodiment;

FIG. 2a-c show an example of an abnormality represented by an inspection device according to FIG. 1 in the control region and it being masked out;

FIG. 3 is a schematic side view of the inspection device according to the disclosure according to a second exemplary embodiment; and

FIGS. 4a, 4b, 4c, 4d, 4e, and 4f show an example of abnormalities represented by an inspection device according to FIG. 3 in the control region and them being masked out.

### DETAILED DESCRIPTION

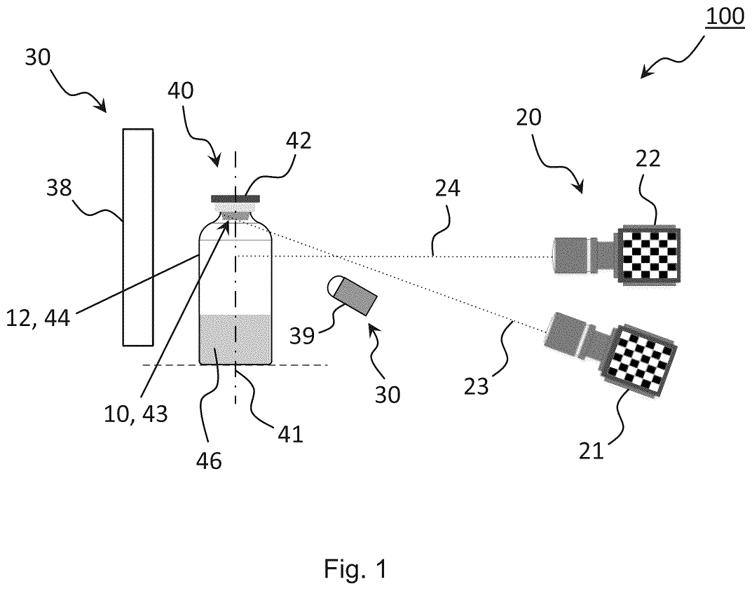

FIG. 1 is a schematic side view of a first exemplary embodiment of the inspection device 100 according to the disclosure. In the exemplary embodiment shown here, the object 40 to be inspected is an inspection bottle or vial 40, wherein it is emphasised that the inspection method according to the disclosure can be used for any at least partially transparent objects, such as ampoules, syringes, cartridges or other containers.

The vial 40 comprises a transparent side wall 44 comprising a base and a shoulder tapering into a neck. In the neck of the vial 40 sits a stopper 42, which seals the vial 40 closed. In FIG. 1, the contents of the vial 40 are denoted by reference sign 46 (this can for example be a liquid, powder or lyophilisate).

In the present exemplary embodiment, an inspection of the stopper is intended to be performed, wherein the underside 43 of the stopper 42 is intended to be examined for abnormalities (i.e. in particular defects and contaminants). This is done by means of an optical capturing apparatus 20, which, in the exemplary embodiment shown, comprises two cameras 21, 22, of which the capturing or viewing directions 23, 24 have an angular offset from one another. As a result, images of the vial 40 are captured from different viewing angles and are then analysed, for example by a computer unit of the inspection device 100 (not shown). In this case, a first camera 21 is directed towards the side of the vial 40 obliquely from below such that it “sees” the stopper underside 43. A first image generated by the first camera 21 thus comprises a representation of the stopper underside 43, such that it can be examined for abnormalities. In this inspection, the stopper underside 43 thus constitutes the inspection region 10 of interest.

In an optical inspection of this kind, the problem arises that the transparent glass wall 44 (in the case shown, including the shoulder) of the vial 40 is located between the stopper underside 43 or the inspection region 10 and the first camera 21. An optical inspection merely based on the image from the first camera 21 would therefore not provide a reliable statement on the presence of abnormalities in the inspection region 10 owing to the lack of depth information, since an abnormality identified in the first image could also be on or in the glass side wall 44. In the inspection considered here, however, the glass side wall 44 of the vial 40 merely constitutes a control region 12, which (at least in the inspection considered here) is not intended to be examined for abnormalities, but is always in the field of view of the capturing apparatus 20 during the stopper inspection.

In the exemplary embodiment in FIG. 1, it is possible to reliably identify abnormalities in the control region 12 in that the second camera 22 views or represents the vial 40 at an offset angle. In the exemplary embodiment shown, the angular offset is selected such that the second camera 22 does not “see” the stopper underside 43, but represents only the control region 12, i.e. the glass side wall 44. For this purpose, the second camera 22 can be directed towards the vial 40 from the side (i.e. approx. 90° to the longitudinal axis of the vial 40). During the stopper inspection, an angular offset of less than 90° can be expedient, although other angles are not ruled out. Furthermore, the angular offset is also expediently selected depending on the type and geometry of the object to be inspected, and in principle is not limited to particular values. In the exemplary embodiment shown, said angular offset is in a plane which also contains the longitudinal axis or axis of rotation 41 of the vial 40 (and not approximately transversely to the longitudinal axis or axis of rotation 41).

The second camera 22 generates a second image, in which the inspection region 10 is therefore not represented and the control region 12 is represented at a different angle to in the first image. As a result, the position of an abnormality in the control region 12 also changes, such that it can be identified as an external abnormality, i.e. not one in the inspection region. More specifically, the abnormality identified in the second image has to be such an external abnormality, since the second camera 22 does not represent the inspection region 10. As a result, a “false reject” can (at least on the basis of the stopper inspection; at another inspection station at which the glass side wall is examined for abnormalities, however, depending on the type of abnormality, abnormalities can indeed be positively identified and ultimately the vial 40 can be rejected).

In principle, the object 40 can be illuminated in any manner. In the exemplary embodiment shown, a combination of transmitted light illumination, in particular by means of an area light 38, and incident light illumination, in particular by means of LED line light 39, is used, wherein the latter provides the required illumination for the first camera 21 for representing the stopper underside 43. Other illuminations can also be used, however (e.g. transmitted light illumination for the stopper underside 43). In principle, the illuminations used can be the same colour or different colours.

In order to identify abnormalities on the glass side wall 44 that are impairing the stopper inspection and to eliminate them from the analysis of the inspection region 10, according to the disclosure a mask is calculated which is applied to the first image from the first camera 21. In the method according to FIG. 1 (3D approach or angular offset of the capturing directions), the mask is calculated based on the second image, since the second camera 22 can only detect abnormalities in the control region 12. Abnormalities in the second image can be identified on the basis of known object-identification algorithms (e.g. edge detection, threshold methods and/or machine-learning-based methods).

Since the calculated mask is intended to be applied to the first image, which shows the inspection region 10, a transformation of the second image onto the representation of the first image, or vice versa, needs to be performed. As a result, the abnormalities captured by the second camera 22 are, for example, transformed into the coordinate system of the first image such that the image regions or pixels belonging to the abnormalities identified in the second image can be masked out in the first image. In this case, the mask is generated from the transformed second image. In the transformation, a possible distortion can be taken into account, which for example arises due to the angular offset.

Alternatively, the first image can also be transformed onto the representation of the second image and the mask can be generated directly from the untransformed second image. In the example in FIG. 1, the first camera 21 is positioned obliquely relative to the vial 40, such that the transformation can also be performed by a corresponding calibration of the first camera 21, wherein the first camera 21 is in particular calibrated such that a flat first image is generated in which distortions caused by the oblique position are equalised.

The calculated mask is then applied to the first image. This can involve a multiplication, but optionally a subtraction, of the first image and the image mask, wherein logical functions (e.g. AND or OR) can also be used. The thus obtained masked first image then comprises masked-out image regions 60 which correspond to the positions of the external abnormalities 50 in the control region 12. This masked-out first image can then be analysed for abnormalities in a routine manner (in particular by means of said object-identification algorithms). Abnormalities that are identified in this following analysis are located in the inspection region 10 and are thus relevant to the present inspection.

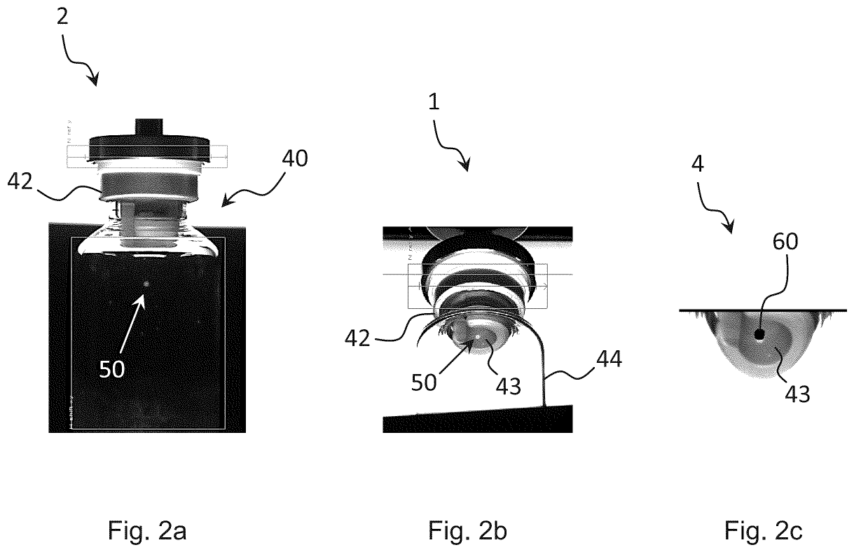

FIG. 2a-c are different views of images of a vial 40 that is inspected using an inspection device according to the exemplary embodiment in FIG. 1 and has an abnormality 50 located on the glass side wall 44. FIG. 2a shows an image captured by the second camera 22 (=second image 2), in which an abnormality 50 is visible in the glass side wall 44 as a light-grey spot (see arrow). FIG. 2b shows the corresponding first image 1 captured by the first camera 21. It is apparent that the external abnormality 50 is on the stopper underside 43 and thus in the middle of the inspection region 10. Only on the basis of the first image 1 would this abnormality 50 therefore potentially be incorrectly identified as an abnormality on the stopper underside 43.

FIG. 2c shows a detail of the masked-out first image 4, wherein the pixels corresponding to the external abnormality 50 identified in the second image 2 are masked out as a black image region 60.

As indicated in FIG. 1 by the line 41, the vial 40 can optionally be rotatable about the longitudinal axis 41 by means of a rotation device, in order to capture first and second images 1, 2 from different sides.

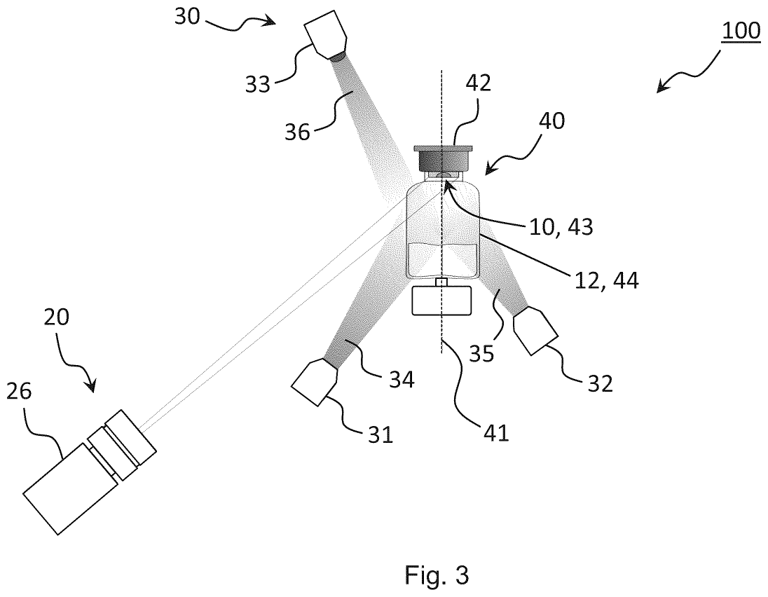

A second exemplary embodiment of the inspection device 100 according to the disclosure is shown schematically in FIG. 3, again on the basis of a vial 40 for the stopper inspection. The principle used for creating the mask is not an angular offset of the capturing units here, but instead an angular offset of the illumination and the use of differently coded illuminations 34, 35, 36. In this exemplary embodiment, the capturing apparatus 20 comprises just one single camera 26, which captures the vial 40 obliquely from below and thus represents both the control region 12 and the inspection region 10 (i.e. the stopper underside 43).

In this exemplary embodiment, the illumination apparatus 30 comprises a plurality of illumination units 31, 32, 33, which can be configured as LED line lights. However, depending on the object 40 to be inspected and the inspection method, other illumination units (e.g. area lights, point lights or combinations of said illumination units) can be used.

A first illumination unit 31 irradiates the vial 40 obliquely from below in a first colour (e.g. blue), such that the stopper underside 43 is illuminated by this first illumination 43 and is detected by the camera 26. A second illumination unit 33 illuminates the vial 40 at an offset angle such that the second illumination 36 does not reach the stopper underside 43, but instead only the glass side wall 44, i.e. impinges on the control region 12. The second illumination 36 is a different colour (e.g. green) from the first illumination 34.

The camera 26 is in particular a colour camera, which comprises at least two sensors and corresponding colour filters and beam splitters associated with the respective sensors, such that the camera 26 provides at least two (in the exemplary embodiment shown, three) images or colour channels, corresponding to the number of different illuminations.

For instance, only the regions (i.e. the control region 12 and the inspection region 10) of the vial 40 irradiated by means of the first illumination 34 can be represented in a first image 1 and only the regions (i.e. the control region 12) of the vial 40 irradiated by means of the second illumination 36 can be represented in a second image 2. The difference in the representations of the first and second images 1, 2 thus originates from the angular offset of the first and second illumination units 31, 33 and the different colours of the first and second illuminations 34, 36. Alternatively or additionally to a difference in the spectral colours, the illuminations 34, 36 can also differ in their polarisation, wherein corresponding polarisation filters would need to be used for this purpose.

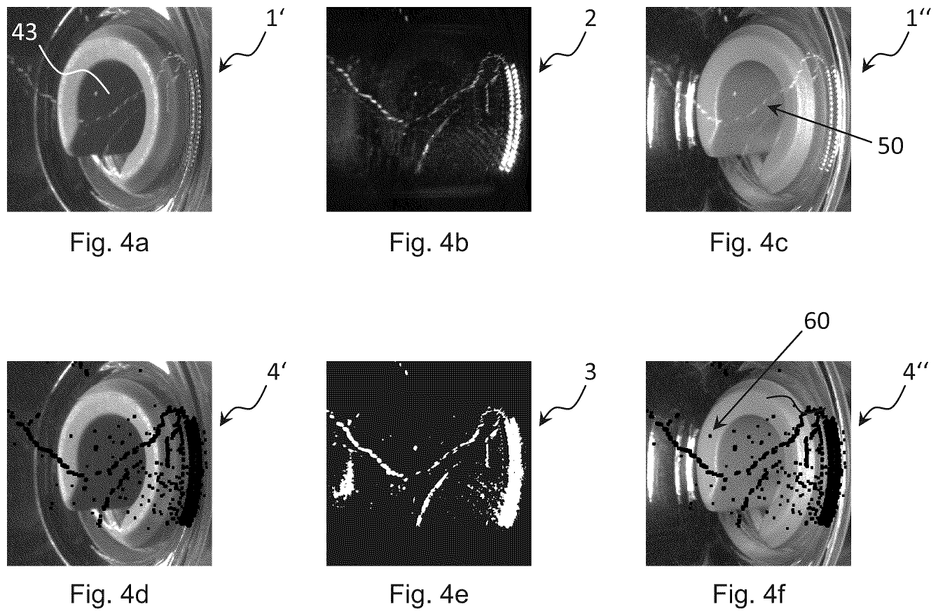

The thus obtained images are shown in FIG. 4a (first image 1′, in said example the blue colour channel) and FIG. 4b (second image 2, in said example the green colour channel) on the basis of a specific example. The stopper underside 43 is represented in the first image 1′, wherein abnormalities 50 drawn in light grey are visible in the image field (cf. also FIG. 4c). They are clearly visible in the second image 2. They are therefore external abnormalities 50 on the glass side wall 44.

In the exemplary embodiment shown in FIG. 3, there is a third illumination unit 32, which illuminates (=third illumination 32) the vial 40 in a third colour (e.g. red) obliquely from below, but on the side of the vial 40 opposite the first illumination unit 31. This results in a third colour channel and thus another first image 1″ (see FIG. 4c), which likewise shows the stopper underside 43. This further illumination unit 32 is not necessarily required, but can improve the inspection result (depending on the colour of the stopper 42 and the vial contents 46, the desired colour or illumination unit 31, 32 can be selected; alternatively, however, the illumination units 31, 33 could also be configured such that they emit light having an adjustable colour). The illuminations 34, 35 of the first and third illumination units 31, 32 could also be jointly referred to as the first illumination. It goes without saying that there can be more than three illumination units.

Alternatively or additionally, two or more images of the control region, i.e. a plurality of second images, could also be generated using different illuminations, for example in order for it to be possible to optimally detect abnormalities having different absorption properties.

Instead of different illumination (different wavelength and/or polarisation), an identical illumination from different angles but with a time offset can also be performed. As a result, the first and second images can be separated over the time offset. In this case, a simpler capturing unit, for example a black-and-white camera or a camera comprising a single sensor, can then be used.

In the principle considered here (angular offset of the illumination), a transformation between the first and second images 1′, 2 does not need to be carried out, since the images 1′, 1″, 2 have been captured by the same camera 26. Therefore, the mask can be calculated directly from the second image 2. FIG. 4e shows the mask generated from the second image as a binary image mask once the abnormalities 50 represented in the second image 2 have been identified by means of object identification.

FIG. 4d shows the image 4′, which is masked out after applying the mask 3 to the first image 1′ and is used for the further search for abnormalities in the inspection region 10. FIG. 4f shows the corresponding masked-out image 4″ for the other colour channel (first image 1″ in FIG. 4c).

The first image can also constitute a superimposition of different colour channels (in the specific example, therefore a superimposition of the images 4a and 4c).

It goes without saying that the principles in the two exemplary embodiments in FIGS. 1 and 3 can be combined with one another, i.e. for example two cameras 21, 22 having different viewing angles combined with an illumination from different angles by means of different colours and/or polarisations.

### LIST OF REFERENCE SIGNS

1, 1′, 1″ First image
2, 2′, 2′ Second image
3 Mask
4 Masked image
10 Inspection region
12 Control region
20 Capturing apparatus
21 First capturing unit (camera)
22 Second capturing unit (camera)
23 Capturing direction of the first capturing unit
24 Capturing direction of the second capturing unit
26 Capturing unit (camera)
30 Illumination unit
31 First illumination unit
32 Second illumination unit
33 Third illumination unit
34 First illumination
35 Second illumination
36 Third illumination
38 Illumination unit (area lighting)
39 Illumination unit (line lighting)
40 Object to be inspected
41 Axis of rotation/longitudinal axis of the object
42 Stopper
43 Stopper underside
44 Glass wall
46 Contents
50 Abnormality in the control region
60 Masked-out region

1. Method for optically inspecting at least partially transparent objects, comprising the steps of:
capturing a first and a second image of an object to be inspected, wherein, for this purpose, the object is captured and/or illuminated from different angles and the images differ from one another on the basis of the angular offset,
identifying an abnormality in the second image,
calculating a mask based on the identified abnormality,
applying the mask to the first image in order to obtain a masked image of the object, and
analysing the masked image to identify abnormalities in an inspection region of the object.

2. Method according to claim 1, wherein at least one masked-out region of the masked image is excluded from the further analysis for identifying abnormalities.

3. Method according to claim 1, wherein the first and second images are captured simultaneously by means of a capturing apparatus.

4. Method according to claim 1, wherein the control region and the inspection region constitute different and non-overlapping portions of the object to be inspected.

5. Method according to claim 1, wherein the first image comprises a representation of the inspection region and a representation of the control region, wherein the second image likewise comprises a representation of the control region, which differs from that of the first image.

6. Method according to claim 5, wherein the object is captured from different angles, wherein the second image is captured at such an angle that the second image does not comprise a representation of the inspection region.

7. Method according to claim 1, comprising the following steps:
generating a transformed image from the second image by means of a coordinate transformation, which brings the representation of the object in the second image into line with the representation of the object in the first image, and
calculating the mask based on the transformed image.

8. Method according to claim 1, wherein a plurality of pairs of first and second images of the object to be inspected are captured and analysed, wherein the object is moved, optionally rotated, particularly optionally continuously rotated, between the shots of the image pairs.

9. Method according to claim 1, wherein the object is illuminated from different angles, wherein a first illumination of the object is performed at a first angle and a second illumination of the object is performed at a second angle, wherein the first and second illuminations differ in their wavelength and/or polarisation, wherein the first and second illuminations originate from a single illumination unit at different points in time or from different illumination units at the same time.

10. Method according to claim 9, wherein the inspection region and at least part of the control region of the object are illuminated by the first illumination and at least part of the control region, but not the inspection region, of the object is illuminated by the second illumination.

11. Method according to claim 9, wherein the second image comprises a representation of the object generated only by the second illumination, wherein the second image is generated using at least one filter that blocks the first illumination.

12. Inspection device for optically inspecting at least partially transparent objects, in particular pharmaceutical containers, by means of a method according to claim 9, comprising a capturing apparatus for generating a first and a second image of an object to be inspected, an illumination apparatus, an analysis means, wherein the object can be captured from different angles by means of the capturing apparatus and/or can be illuminated from different angles by means of the illumination apparatus, wherein the analysis means is configured to analyse the generated images, which differ from one another on the basis of the angular offset, to identify an abnormality in the second image, to calculate a mask based on the identified abnormality, to apply the mask to the first image, and to analyse the thus obtained masked image for the presence of abnormalities in an inspection region of the object.

13. Inspection device according to claim 12, wherein the capturing apparatus comprises two separate capturing units by means of which the two images can be captured simultaneously from different angles.

14. Inspection device according to claim 12, wherein the illumination apparatus comprises at least two separate illumination units, LED lights, by means of which the object can be illuminated simultaneously from different angles, wherein the illuminations generated by the illumination units on the object in particular differ from one another in their wavelength and/or polarisation, wherein at least one illumination unit is movable relative to the object by means of an adjusting apparatus.

15. Set comprising an analysis means and a capturing apparatus and/or an illumination apparatus of an inspection device according to claim 12 for retrofitting an existing inspection device.

16. Method according to claim 1, wherein partially transparent objects are pharmaceutical containers.

17. Method according to claim 2, wherein the masked-out region is optionally at least partially in a representation of the inspection region.

18. Method according to claim 3, wherein the capturing apparatus comprises at least two separate capturing units.

19. Method according to claim 4, wherein the control region is formed by a transparent portion of the object which lies in front of the inspection region in the viewing direction of the first image.

20. Inspection device according to claim 13, wherein two separate capturing units are cameras, wherein at least one capturing unit is movable relative to the object by means of an adjusting apparatus.
